(19) United States
(12) Patent Application Publication
(10) Pub. No.: US 2008/0246609 A1
(43) Pub. Date: Oct. 9, 2008

(54) Rf Identification and Security System

(75) Inventors: Kwai Leng Tang, Singapore (SG); Chee Weng Chan, Singapore (SG)

Correspondence Address: MICHAEL BEST & FRIEDRICH LLP, 100 E WISCONSIN AVENUE, Suite 3300, MILWAUKEE, WI, 53202, US

(73) Assignee: ST LOGITRACK PTE LTD, Singapore (SG)

(21) Appl. No.: 12/065,035

(22) PCT Filed: Aug. 31, 2006
(86) PCT No.: PCT/SG2006/000252

§ 371 Date: Feb. 27, 2008

(30) Foreign Application Priority Data
Aug. 31, 2005 (SG) 200505587-6

(51) Int. Cl. G08B 13/14; G06K 19/07

(52) U.S. Cl. 340/568.1; 340/10.1

(57) ABSTRACT

The identification and security system is for an item (10) particularly a data storage disk, CD, DVD, etc. being borrowed by system user (11) from a library. The item comprises a data storage disk (16) mounted in a storage case (20). RF transponder means (25, 30) are mounted by the item (10) to provide identification data and security data with the data being readable from RF signals transmitted by the transponder means in response to external interrogation signals. The transponder means comprises a first RF transponder (25) which is a relatively smaller sized transponder, particularly an RFID transponder tag mounted in the annular space (18) between the central hole (17) and the inside diameter of the data storage area (19) of the disk (16). A relatively larger size transponder (30) provides improved detectivity due to the larger size. The transponder (30) can also comprise an RFID tag (30) mounted at a corner of the storage case (20), shown at a corner of the lid (21) at a location at least partially radially beyond the outside diameter of the data storage area (19) of the disk (16) when the case (20) is closed. By at least partially locating the antenna of the second RFID tag (30) radially beyond the data storage area (19) of the disk (16), the second transponder is not shielded by the data storage area (19) and hence the detectivity, particularly the range from which the second transponder can be detected, is greatly improved. Security data is stored by the second transponder, and identification data by the first transponder, with some data being redundantly stored by both.

This invention relates to systems and processes, and to apparatus used therein, for controlling and tracking of transactions involving individual items, such as items being used in, borrowed from, and returned to libraries.

Although the systems and processes will be particularly described in relation to library systems involving user transactions related to items in the possession of or belonging to libraries, the invention is applicable to other analogous fields where items or products are stored, used, moved and otherwise processed in transactions, such as stock control in business or industrial applications, control of transactions involving tools, plant or equipment or other supplies in business or commercial or industrial establishments, in wholesale or retail establishments involving transactions with items being moved by personnel including employees or staff and customers or clients. Also, when referring to libraries, it is to be understood that this term encompasses not only lending libraries such as public or school or academic libraries, but also commercial libraries where items are borrowed and returned in commercial rental transactions.

It is known to mount RF transponders to items in libraries so that the library users can borrow and return the items to which the transponders are mounted in at least partially automated transactions. For example, in the patent specification of international patent application No. PCT/SG98/00041 (publication No. WO99/64974) and related U.S. Pat. No. 6,704,690 there is described a library monitoring system for items which have RF transponders attached thereto, the transponders storing identification data which is transmitted to an interrogation apparatus provided at the library. Users of the library present items being borrowed, together with some user identification, and the data read from the transponder is associated with the user and stored with minimal or no intervention or involvement of library staff. The RF transponders also facilitate security operations because items carrying the RF transponders can be detected remotely e.g. if an item is being taken from the library without having a borrowing transaction for the item having been successfully concluded and recorded. Reference may be made to that patent specification for considerably more detail about the nature of the RF transponders, data that can be stored and transmitted and exchanged with the library system, and a considerable amount of this background information is applicable to the present invention so there is no need to repeat substantial amounts of the contents of that specification here for understanding the present invention.

The present invention more particularly relates to an identification and security system for items to be processed in transactions with system users, each of said items comprising a data storage medium and a container in which the medium is located, the system including:

RF transponder means mounted by each item and having identification data and security data stored thereby, the data being readable from RF signals transmitted by the RF transponder means in response to external interrogation signals; and

interrogation apparatus effective to remotely read the RF signals from the RF transponder means and operative to process the identification data and security data derived from the RF signals and to control the transaction involving the respective item dependent on the data processed.

One problem or difficulty encountered with RF transponder systems used for identification and security functions relates to items which comprise or contain data storage media, particularly CDs, DVDs, VCDs and the like. The problem is associated with the metallic coatings on the media which interfere with the RF interrogation operation. In particular, mounting an RF transponder to a data storage disk having metallic coatings can reduce the effective detection range to impractically short distances, e.g. 10-20 cm. It will be appreciated that in library item borrowing transactions, detection at such short ranges will mean that there is inadequate security with the result that library items can be inadvertently or deliberately removed from the library without detection.

In fact some suppliers of RF transponder systems tell their customers (libraries using their systems) that it is impossible to secure CDs, DVDs, etc and the suppliers recommend to the customers that such media be issued to users by staff at the service counters, rather than displaying such items on shelves for users to select the items and use the automatic self-service facilities available for other items in loan and return transactions.

It is an object of the present invention to provide identification and security systems for items having data storage media which can readily and effectively be processed in transactions with system users.

According to the present invention there is provided an identification and security system for items to be processed in transactions with system users, each of said items comprising a data storage medium and a container in which the medium is located, the system including:

RF transponder means mounted by each item and having identification data and security data stored thereby, the data being readable from RF signals transmitted by the RF transponder means in response to external interrogation signals; and

interrogation apparatus effective to remotely read said RIF signals from said RF transponder means and operative to process the identification data and security data derived from the RF signals and to control the transaction involving the respective item dependent on the data processed;

wherein said RF transponder means includes:

a first RF transponder mounted by the respective data storage medium in a position enabling remote interrogation thereof and enabling reading from the responsive RF signals of data stored by that first transponder, the data stored and transmitted by the first transponder including item identification data that identifies the particular data storage medium by which the first transponder is mounted; and

a second RF transponder mounted by the container in which the data storage medium mounting the first transponder is located, the second RF transponder being mounted in a position separated from close proximity to the first transponder and enabling remote interrogation thereof and enabling reading from the responsive RF signals from the second transponder of data stored thereby, the data stored and transmitted by the second transponder including security status data that provides security related information effecting allowable transactions involving the respective item and further including at least some item identification data related to the particular data storage medium within the container and consistent with item identification data stored by the respective first transponder.

By providing two RF transponders, one mounted by the data storage medium and the other by the associated container, it can be possible to improve the detectivity of items to be processed in the transactions with system users.

A further possible advantage that can, although not necessarily, arise from using two transponders is that it is possible to provide some redundancy of data so that if one of the transponders is missing or damaged or otherwise not detected by the interrogation apparatus, the remaining detected transponder can still provide a security function.

Preferably the data stored and transmitted by the first transponder further includes security status data that provides security related information affecting allowable transactions involving the respective item.

The security status data preferably includes data indicating an armed or disarmed status of the respective item, the interrogation apparatus being operative to read the security status data and to disallow or allow predetermined transactions involving the respective item dependent on the armed or disarmed status.

The item identification data stored and transmitted by the first transponder may include data unique to, and therefore uniquely identifying, the particular data storage medium by which that first transponder is mounted. The item identification data that uniquely identifies the particular data storage medium may comprise an item identification code by which the respective item is uniquely identified and which is linked in use with data identifying a particular system user who is engaged in a transaction involving the respective item.

Preferably some item identification data stored and transmitted by the second transponder includes at least some item identification data in common with the item identification data stored by the first transponder of the respective item, whereby there is at least some redundancy of item identification data stored by the first and second transponders of each item. The redundant item identification data preferably includes type data which contains information concerning the item classification type enabling the interrogation apparatus to detect the particular type of item from which RF signals are being read and to initiate a relevant data processing operation in response thereto.

The first RF transponder may be a relatively smaller sized transponder mounted by the respective data storage medium and the second RF transponder may be a relatively larger size transponder having higher detectivity than the first transponder. In some possible operations, such as in a check-out operation in a library, if the interrogation apparatus detects and reads RF signals from the second transponder only, the interrogation apparatus may thereupon scan RF signals being detected thereby for the expected RF signals from the associated first RF transponder and will generate an alarm signal if those expected RF signals from the first RF transponder are not detected. However, it is to be understood that in some operations, e.g. a security check at the exit of a library, the determination of the security status of one transponder only may suffice without needing to scan for, locate, and check for the other transponder. Also, the sequence of detection may be random if both transponders are in a detection zone.

The system is particularly suitable where the data storage medium of the item comprises a data storage disk having: a central hole therethrough for centring the disk during data reading or writing operations, and an annular data storage area surrounding the central hole and the inside diameter the central hole of the annular data storage area. In this case the first RF transponder can be mounted in the annular space between the central hole and the inside diameter of the data storage area. The container of the item may comprise a storage case for receiving and locating the data storage disk therein, and the second RF transponder may be mounted at a corner of the storage case at a location at least partially radially beyond the outside diameter of the data storage area of the data storage disk.

In this particular application for which the present invention has been particularly developed, the first transponder may for example comprise an antenna which is about 40 mm in diameter and which surrounds the centre hole of disk. This transponder can be used primarily for item check-in (or return) or check-out (or borrowing) functions as well as providing functionality of the armed or disarmed status for security purposes.

The second transponder of larger size is placed at a corner of the storage case for the disk, the second transponder being used primarily to enhance the security management functionality by storing and transmitting the armed or disarmed status used in electronic article surveillance (EAS). The larger second transponder can also store the type data, comprising the item classification type and transmit this to the interrogation station, this item classification type basically providing quick identification that there is an associated data disk such as a CD, DVD, etc that requires additional security features and identification and additional security operations in the relevant transaction with the system user carrying the item.

Preferably the first RF transponder and the second RF transponder both store redundant item identification data and redundant security status data, the redundant item identification data including: type data which contains information concerning the item classification type enabling the interrogation apparatus to detect the particular type of item from which RF signals are being read and to initiate a relevant data processing operation in response thereto, and an item identification code which uniquely identifies the item;

the redundant security status data including data indicating an armed or disarmed status of the item, the interrogation apparatus being operative to read the security status data and to disallow or allow predetermined transactions involving the respective item dependent on the armed or disarmed status. The redundant data stored by both the first RF transponder and the second RF transponder may further include housekeeping data which includes at least data indicating the provenance or the ownership of the respective item.

The first RF transponder may include additional data stored and transmitted thereby, the additional data being selected from:

a branch code which identifies a sub-category of provenance or ownership of the item,

a sort code which defines one of a number of sorting categories in which the item can be classified for storage and selective retrieval,

a status code which provides information about one of a number of possible transactions in which the item has last been involved,

transaction history data providing information on prior transactions in which the item has been involved, and

publisher or producer information data.

In a second aspect the present invention also provides a system in use in a library with the items to be processed in transactions with system users comprising data storage disks stored within respective storage cases, and wherein the transactions involving the items include permitted borrowings and subsequent returns of the items by library users, the system being operable upon library users providing user identification at the time of each item transaction using the system, and the interrogation apparatus being operatively associated with data storage means for associating the library user identification with the respective item being borrowed.

Possible and preferred features of the present invention will now be described with particular reference to the accompanying drawings. However it is to be understood that the features illustrated in and described with reference to the drawings are not to be construed as limiting on the scope of the invention. In the drawings:

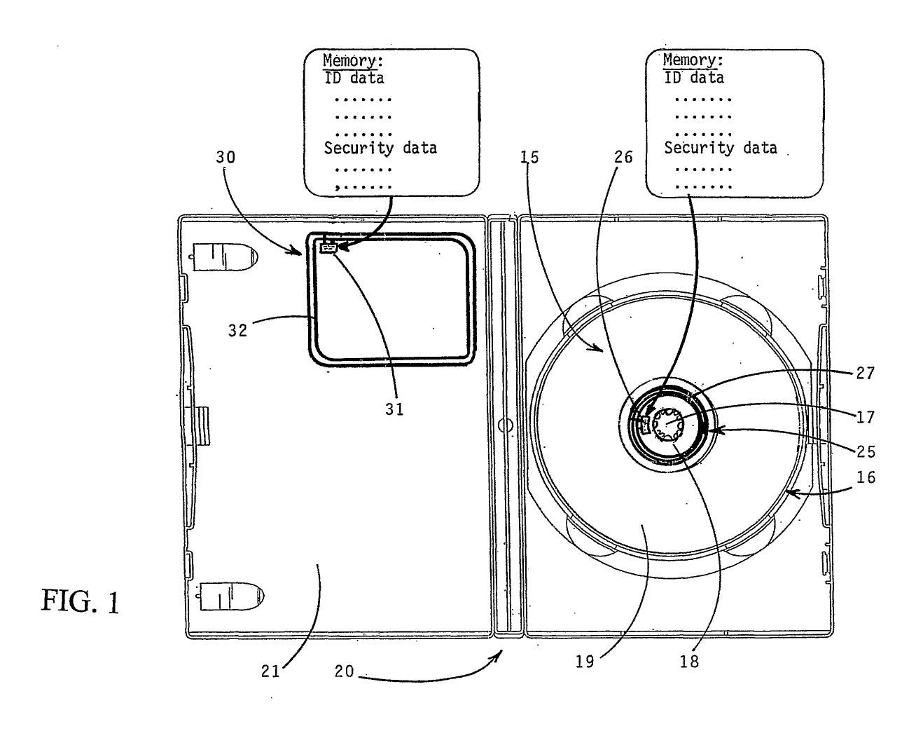

FIG. 1 illustrates an item having a data storage disk and associated case with RF transponders useable in a system of the present invention,

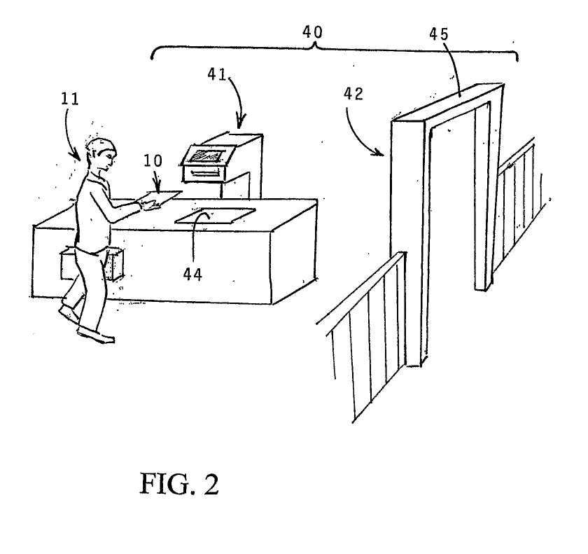

FIG. 2 schematically illustrates a system user presenting at a transaction station,

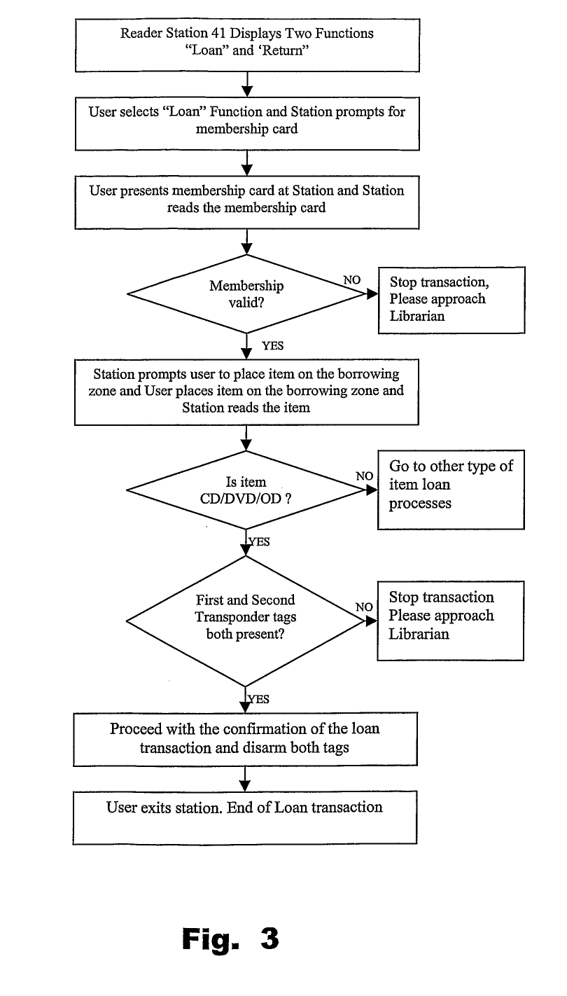

FIG. 3 indicates some possible processes in a transaction involving an item being borrowed from a library, and

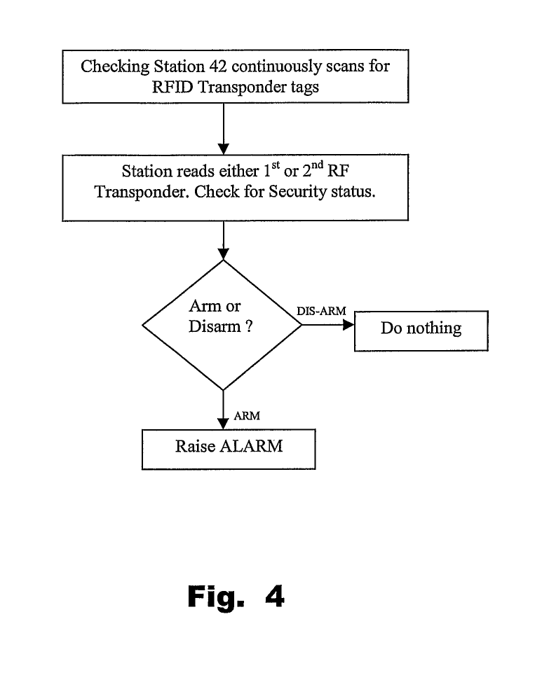

FIG. 4 indicates possible operations at a checking station for security purposes.

The system illustrated in the drawings provides identification and security functions for an item 10 being borrowed by system user 11 from a library where the system is in use. The item comprises a data storage medium 15 shown as a data storage disk mounted in a storage case 20 which is shown having generally conventional construction. The disk 16 has a central hole 17 for centring the disk during data reading and writing operations and by which the disk is held within the casing 20. An annular space 18 is provided between the central hole 17 and the annular data storage area 19.

RF transponder means 25, 30 are mounted by the item 10 to provide identification data and security data with the data being readable from RF signals transmitted by the transponder means in response to external interrogation signals.

The transponder means comprises a first RF transponder 25 which is a relatively smaller sized transponder, particularly an RFID transponder tag mounted in the annular space 18 between the central hole 17 and the inside diameter of the data storage area 19 of the disk 16. The RFID tag 25 may comprise for example an IC chip 26 having an associated memory in which data is stored and an RF receiving and transmitting antenna 27.

The transponder means also includes a relatively larger size transponder 30 so as to thereby provide improved detectivity due to the larger size. The transponder 30 can also comprise an RFID tag with its respective IC chip 31 and antenna 32, the chip 31 having an associated memory in which data is stored. The RFID tag 30 is mounted at a corner of the storage case 20, shown at a corner of the lid 21 at a location at least partially radially beyond the outside diameter of the data storage area 19 of the disk 16 when the case 20 is closed. By at least partially locating the antenna of the second RFID tag 30 radially beyond the data storage area 19 of the disk 16, the second transponder is not shielded by the data storage area 19 and hence the detectivity, particularly the range from which the second transponder can be detected, is greatly improved.

The two RFID tags 25, 30 may be operable at the same radio frequency. Because RFID frequency bands are regulated by government or similar authorities, allowable frequency bands for purposes of the present system are already congested so that using the same frequency for both transponders is likely to be more acceptable to regulatory authorities. Also using a common frequency for both transponders can simplify the electronics of the interrogation and processing system compared to using different frequencies. A suitable frequency for the RFID tags for example may 13.56 MHz. It is to be appreciated, however, that the present invention is not limited to transponders operating at a single common frequency.

The RFID tags useable in the present system can be standard “off the shelf” items without needing customisation. The nature and format of the data to be programmed into the tags can be accommodated with such standard “off the shelf” transponders (although the type and format of the information may be unique to the system of the present invention). The tags can be based, for example, on open standards such as Philips I-code 1, Philips I-code SLI, Infineon, or can be based on proprietary standards developed by manufacturers and suppliers of RFID tags and readers.

The system includes interrogation apparatus 40 indicated schematically in FIG. 2 which is effective to remotely read RF signals from the transponders 25, 30 and to process the identification data and security data derived from the RF signals and thereby control the transaction involving the respective item 10 dependent on the data received and processed. As schematically shown in FIG. 2, the system can be in use in a library and the items to be processed in transactions with a system user 10 comprise the data storage disks 16 stored within the storage cases 20. The transactions involving the items 10 can include permitted borrowings and subsequent returns of the items by the library users 11. The user 11 can provide user identification at the time of each item transaction using the system, e.g. by the user 11 carrying or presenting an ID data carrier such as a smart card which may also be detected and interrogated remotely by RF signals. For example, the user 11 may present a membership card at a reader station 41 so that the user's identity and other information concerning the user's ability or authority to borrow items from the library can be read and used in controlling the respective transactions. A borrowing zone 44 is provided where the user is prompted to place the item 10 for scanning. The interrogation apparatus 40 would be operatively associated with data storage and processing means which is operative to associate the library user identification with the respective item being borrowed. FIG. 3 shows possible functions performed by the interrogation apparatus 40 during a library loan process undertaken at the reader station 41. Although exemplifying a loan process, it will be understood that the flow diagram in FIG. 3 for reader station 41 describes a loan process only and that the same logic flow will be applicable for the return of items to the library, i.e. only when both transponders 25, 30 are detected, then the item 10 will be successfully returned, otherwise, the item should not be registered as returned to the library. The interrogation apparatus 40 can also include a checking station 42 having a gantry 45 through which the user 11 passes, the gantry including RF antennas to transmit and receive RF signals to and from the transponders of the item 10. FIG. 4 shows possible functions performed by the interrogation apparatus 40 at the checking station 42 for EAS purposes. These kinds of processes and operations can be generally conventional and such types of processes can be understood by referring to the previously mentioned patent specifications WO99/64974 or U.S. Pat. No. 6,704,690.

The first transponder 25 stores and transmits data item identification data that identifies the particular data storage medium 15 by which the first transponder 25 is mounted. The data stored and transmitted by the second transponder 30 includes security status data that provides security related information affecting allowable transactions involving the respective item 10 and farther includes at least some item identification data related to the particular data storage medium 15 within the container 20 and consistent with item identification data stored by the respective first transponder 25.

The data stored and transmitted by the first transponder 25 also includes security status data that provides security related information affecting allowable transactions involving the respective item 10. The security status data includes data indicating an armed or disarmed status of the respective item. The interrogation apparatus 40 is operative to read the security status data and to disallow or allow predetermined transactions involving the respective item 10 dependent on the armed or disarmed status. The item identification data stored and transmitted by the first transponder 25 is unique to, and therefore uniquely identifies, the particular data storage medium 15 by which the first transponder 25 is mounted. In particular, the item identification data that uniquely identifies the particular data storage medium 15 can comprise an item identification code by which the respective item is uniquely identified and which is in use linked with data identifying a particular system user who is engaged in a transaction involving the respective item.

Item identification data stored and transmitted by the second transponder 30 includes at least some item identification data in common with the item identification data stored by the first transponder 25 of the respective item, whereby there is at least some redundancy of item identification data stored by the first and second transponders 25, 30 of each item 10. The redundant item identification data includes type data which contains information concerning the item classification type enabling the interrogation apparatus 40 to detect the particular type of item 10 from which RF signals are being read and to initiate a relevant data processing operation in response thereto.

In one possible operation, if the interrogation apparatus 40 (at either the reader station 41 or checking station 42) detects and reads RF signals from the second transponder 30, the interrogation apparatus may thereupon scan RF signals being detected thereby for the expected RF signals from the associated first RF transponder 25 and will generate an alarm signal if those expected RF signals from the first RF transponder are not detected. The “alarm signal” may be a visual or audio signal, or may be an electrical signal to initiate another response such as a closure of an exit gate or an alert to a staff member. In general, interrogator 40 will detect the second transponder first because of its larger size and hence better detectivity. However, the interrogator does not necessarily then look for the first transponder. For example, at checking station 42, if the interrogator detects the second transponder and determines that the information is correct (i.e. disarmed status), the process ends there. However, at reader station 41, the interrogator 40 will actually look for the first transponder if it detects the second transponder as more information is stored in first transponder, though it should be noted that the sequence of detection of the transponders 25, 30 by the interrogator is random if both are within the detection zone.

In a particular preferred embodiment, both of the RFID tags 25, 30 therefore perform identification and security functions even though separation of the RFID functions into two devices is a central concept of the present invention. In particular while the primary function of the first RFID tag at the centre of the disk is to provide identification data, the first transponder tag can also provide security functionality. However, because of its relatively small size the detectivity of the first RFID tag is limited for security purposes. The primary function of the second transponder tag provided on the disk housing is to provide security status as it has good detectivity due to its larger size. Nevertheless the second transponder tag also provides identification data and therefore can perform a back up role of identification, e.g. if the first transponder tag is removed, tampered with, lost or damaged.

In the preferred embodiment, typically both transponder tags contain information data comprising:

(1) type data, or item classification type, which refers to a type of coding system that identifies in the item for example is a single book, a multi volume work, a CD, a video tape, etc—in the system of the present invention, the type data identifies the item as a data storage medium such as a CD whereupon the interrogation station will scan for another transponder tag with the same identification code;

(2) item identification code (sometimes called “item code”) which uniquely identifies the item, this code sometimes being known as an “accession code” or “accession number” and which is allocated to the item upon first acquisition and integration of the item into the collection of the library;

(3) a security status, namely the “armed” or “disarmed” status to be used for security management functionality;

(4) housekeeping data such as a “family code” and “application code” which identify the customer and the industry sector, e.g. library, warehouse, retail, etc.

The first RF transponder may also include additional data stored and transmitted thereby, the additional data being selected from:

(1) a branch code which identifies a sub-category of providence or ownership of the item (this can be particularly useful in a public library network where an item borrowed from one branch may be returned to any of the other branches);

(2) a sort code which defines one of a number of sorting categories into which the item can be classified for storage and selective retrieval, e.g. sorting categories that the library adopts for easy shelving);

(3) a status code which provides information about one of a number of possible transactions in which the item has last been involved (e.g. if an item is on loan, or is reserved, or belongs to another branch, or is in transit back to the original branch, etc);

(4) transaction history data providing information on prior transactions in which the item has been involved (e.g. number of loans);

(5) publisher or producer information data (e.g. a code for publisher, ISBN, ISSN, etc).

Besides reading the family and application codes to determine if the item belongs to the library, the RFID equipment is able to identify the item classification type and perform the process accordingly. For example, if a CD tag is detected at the borrowing station, the station will scan for a case tag, process the loan and then “disarm” both tags. Similarly, at a return station, both tags are read, return of the CD is registered, and then, both tags are “armed” and hence the item is secured.

FIGS. 3 and 4 show schematically several operations that can be performed by the interrogation apparatus and associated transaction monitoring and control system. The various operations illustrated in the flowcharts of FIGS. 3 and 4 can be readily understood from the preceding description and also from similar processes and operations performed by known library transaction control systems, such as those described in patent specification WO99/64974 or U.S. Pat. No. 6,704,690.

It is to be understood that various alterations, modifications and/or additions may be made to the features of the possible and preferred embodiment(s) of the invention as herein described without departing from the spirit and scope of the invention as defined in the claims.

1. An identification and security system for items to be processed in transactions with system users, each of said items comprising a data storage medium and a container in which the medium is located, the system including:
RF transponder means mounted by each item and having identification data and security data stored thereby, the data being readable from RF signals transmitted by the RF transponder means in response to external interrogation signals; and
interrogation apparatus effective to remotely read said RF signals from said RF transponder means and operative to process the identification data and security data derived from the RF signals and to control the transaction involving the respective item dependent on the data processed;
wherein said RF transponder means includes:
a first RF transponder mounted by the respective data storage medium in a position enabling remote interrogation thereof and enabling reading from the responsive RF signals of data stored by that first transponder, the data stored and transmitted by the first transponder including item identification data that identifies the particular data storage medium by which the first transponder is mounted; and
a second RF transponder mounted by the container in which the data storage medium mounting the first transponder is located, the second RF transponder being mounted in a position separated from close proximity to the first transponder and enabling remote interrogation thereof and enabling reading from the responsive RF signals from the second transponder of data stored thereby, the data stored and transmitted by the second transponder including security status data that provides security related information effecting allowable transactions involving the respective item and further including at least some item identification data related to the particular data storage medium within the container and consistent with item identification data stored by the respective first transponder.

2. A system as claimed in claim 1 wherein the data stored and transmitted by the first transponder further includes security status data that provides security related information affecting allowable transactions involving the respective item.

3. A system as claimed in claim 1 wherein the security status data includes data indicating an armed or disarmed status of the respective item, the interrogation apparatus being operative to read the security status data and to disallow or allow predetermined transactions involving the respective item dependent on the armed or disarmed status.

4. A system as claimed in claim 1 wherein the item identification data stored and transmitted by the first transponder is unique to, and therefore uniquely identifies, the particular data storage medium by which that first transponder is mounted.

5. A system as claimed in claim 4 wherein the item identification data that uniquely identifies the particular data storage medium comprises an item identification code by which the respective item is uniquely identified and which is linked with data identifying a particular system user who is engaged in a transaction involving the respective item.

6. A system as claimed in claim 1 in which said at least some item identification data stored and transmitted by the second transponder includes at least some item identification data in common with the item identification data stored by the first transponder of the respective item, whereby there is at least some redundancy of item identification data stored by the first and second transponders of each item.

7. A system as claimed in claim 6 wherein the redundant item identification data includes type data which contains information concerning the item classification type enabling the interrogation apparatus to detect the particular type of item from which RF signals are being read and to initiate a relevant data processing operation in response thereto.

8. A system as claimed in claim 1 wherein the first RF transponder is a relatively smaller sized transponder mounted by the respective data storage medium and wherein the second RF transponder is a relatively larger size transponder having higher detectivity than the first transponder, whereby if the interrogation apparatus detects and reads RF signals from the second transponder only, the interrogation apparatus will thereupon scan RF signals being detected thereby for the expected RF signals from the associated first RF transponder and will generate an alarm signal if those expected RF signals from the first RF transponder are not detected.

9. A system as claimed in claim 1 wherein the data storage medium of the item comprises a data storage disk having: a central hole therethrough for centring the disk during data reading or writing operations, and an annular data storage area surrounding the central hole and the inside diameter the central hole of the annular data storage area wherein the first RF transponder is mounted in said annular space between the central hole and the inside diameter of the data storage area.

10. A system as claimed in claim 9 wherein the container of the item comprises a storage case for receiving and locating the data storage disk therein, and wherein the second RF transponder is mounted at a corner of the storage case at a location at least partially radially beyond the outside diameter of the data storage area of the data storage disk.

11. A system as claimed in claim 1 wherein the first RF transponder and the second RF transponder both store redundant item identification data and redundant security status data, the redundant item identification data including:
type data which contains information concerning the item classification type enabling the interrogation apparatus to detect the particular type of item from which RF signals are being read and to initiate a relevant data processing operation in response thereto, and
an item identification code which uniquely identifies the item; the redundant security status data including data indicating an armed or disarmed status of the item, the interrogation apparatus being operative to read the security status data and to disallow or allow predetermined transactions involving the respective item dependent on the armed or disarmed status.

12. A system as claimed in claim 11 wherein the redundant data stored by both the first RF transponder and the second RF transponder further includes housekeeping data which includes at least data indicating the provenance or the ownership of the respective item.

13. A system as claimed in claim 1 wherein the first RF transponder includes additional data stored and transmitted thereby, the additional data being selected from:
a branch code which identifies a sub-category of provenance or ownership of the item,
a sort code which defines one of a number of sorting categories in which the item can be classified for storage and selective retrieval,
a status code which provides information about one of a number of possible transactions in which the item has last been involved,
transaction history data providing information on prior transactions in which the item has been involved, and
publisher or producer information data.

14. A system as claimed in claim 1 wherein the system is in use in a library and the items to be processed in transactions with system users comprise data storage disks stored within respective storage cases, and wherein the transactions involving the items include permitted borrowings and subsequent returns of the items by library users, the system being operable upon library users providing user identification at the time of each item transaction using the system, and the interrogation apparatus being operatively associated with data storage means for associating the library user identification with the respective item being borrowed.
